(19) United States
(12) Patent Application Publication
(10) Pub. No.: US 2011/0165485 A1
(43) Pub. Date: Jul. 7, 2011

(54) Fuel Cell System And Method Of Use

(75) Inventors: Suriyaprakash Ayyangar Janarthanam, Westland, MI (US); Victor Dobrin, Ypsilanti, MI (US)

(73) Assignee: FORD GLOBAL TECHNOLOGIES, LLC, Dearborn, MI (US)

(21) Appl. No.: 12/899,156

(22) Filed: Oct. 6, 2010

(51) Int. Cl. H01M 8/04

(52) U.S. Cl. 429/429; 429/516; 429/428

(57) ABSTRACT

A fuel cell having a cathode and an anode. The cathode has an inlet and an outlet. The fuel cell also includes at least one of a first valve and a second valve. The first valve is situated at and connected to the cathode inlet. The second valve is situated at and connected to the cathode outlet. The fuel cell system also includes a controller configured to control the first and second valves during a first operating condition and a second operating condition. The first operating condition includes the transition of the fuel cell system from an operational state to a non-operational state. The second operating condition includes the transition from a non-operational state to an operational state.

### BACKGROUND

1. Technical Field

One or more embodiments relate to a fuel cell system and a method of use.

2. Background Art

In a typical proton exchange membrane (PEM) based fuel cell system, an anode subsystem provides the necessary hydrogen fuel at the pressure, flow, and humidity to a fuel cell stack for necessary power generation.

During the normal operation of the fuel cell system, when a vehicle ignition key is turned on, the chemical reaction at an anode catalyst layer on an anode side of the fuel cell system involves splitting a hydrogen into an electron and proton. The protons permeate through the membrane to the cathode side. On the cathode side of the membrane, oxygen atoms react with the protons to produce water.

During a soak time period between a shutdown of normal operations and a restart of normal operations, some or all of the remaining unreacted hydrogen on the anode side migrates through the membrane and chemically reacts with the oxygen in the cathode side. Over time, depending upon the length of soak, hydrogen depletes in the anode side. Oxygen or air from the cathode side fills in the anode side to replace the lost hydrogen and increases an anode half cell potential. The oxygen may cause carbon corrosion and ruthenium migration from an anode catalyst layer to a cathode catalyst layer. These processes of corrosion and migration may each result in decreased fuel cell stack life.

### SUMMARY

In at least one embodiment, a fuel cell system includes a fuel cell having a cathode and an anode. The cathode has an inlet and an outlet. The fuel cell system also includes at least one of a first valve and a second valve. The first valve is situated at and connected to the cathode inlet. The second valve is situated at and connected to the cathode outlet. The fuel system also includes a controller, which is configured to control the first and second valves during a first operating condition and a second operating condition. The first operating condition is a transition of the fuel cell system operation from an operational state to a non-operational state. The second operating condition is the transition from a non-operational state to an operational state.

In another embodiment, a fuel cell system has a fuel cell with an anode having a half-cell potential. The fuel cell also includes a cathode having a cathode catalyst layer and a plate spaced apart from the cathode catalyst layer. The cathode catalyst layer and the plate define a cavity therebetween. The cavity includes a gas diffusion layer communicating with a gas conduit defined by the plate. The cathode further includes an oxygen input situated at the upstream end of the gas conduit and a gas outlet situated at the downstream end of the gas conduit. A first valve is situated adjacent to the oxygen inlet. A second valve is situated adjacent to the gas outlet. The fuel cell system includes a conduit connecting the first and second valves to the cathode. The conduit has no intermediate connections therebetween.

In yet another embodiment, a method of operating a fuel cell system when a vehicle engine transitions to a soak time period is disclosed. The fuel cell system includes a cathode and an anode, the anode having a half-cell potential. The method includes the steps of pressurizing the fuel cell cathode at a cathode oxygen pressure. The cathode has an oxygen inlet and a gas outlet. The method further includes the step of transmitting a first signal to a controller to begin the soak time period. The controller transmits a second signal to a first valve situated at the oxygen inlet. The first valve closes in response to the second signal. The method also includes transmitting a third signal from the controller to a second valve situated at the gas outlet. The second valve closes in response to the third signal during the vehicle transition.

### BRIEF DESCRIPTION OF THE DRAWINGS

FIG. 1 schematically illustrates a fuel cell system in a vehicle according to at least one embodiment;

FIG. 2 schematically illustrates a fuel cell system according to at least one embodiment;

FIG. 3 schematically illustrates cross-sectional view of a fuel cell along axis 3-3 of FIG. 2.

FIG. 4 diagrammatically illustrates a method of use of a fuel cell system according to at least one embodiment.

### DETAILED DESCRIPTION

Reference will now be made in detail to presently preferred compositions, embodiments and methods of the present invention, which constitute the best modes of practicing the invention presently known to the inventors. However, it should be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the operating examples, or where otherwise expressly indicated, all numbers in this description indicating material amounts, reaction conditions, or uses are to be understood as modified by the word “about” in describing the invention's broadest scope. Practice within the numerical limits stated is generally preferred. Also, unless expressly stated to the contrary:

percent and ratio values are by weight;

a material group or class described as suitable or preferred for a given purpose in connection with the invention implies any two or more of these materials may be mixed and be equally suitable or preferred;

constituents described in chemical terms refer to the constituents at the time of addition to any combination specified in the description, and does not preclude chemical interactions among mixture constituents once mixed;

an acronym's first definition or other abbreviation applies to all subsequent uses here of the same abbreviation and mutatis mutandis to normal grammatical variations of the initially defined abbreviation; and

unless expressly stated to the contrary, measurement of a property is determined by the same technique as previously or later referenced for the same property.

In a typical proton exchange membrane (PEM) based fuel cell system, an anode subsystem provides the necessary hydrogen fuel at the pressure, flow, and humidity to a fuel cell stack for necessary power generation.

During the normal operation of the fuel cell system, when a vehicle ignition key is turned on, the chemical reaction at an anode catalyst layer on an anode side of the fuel cell system involves splitting a hydrogen into an electron and proton. The protons permeate through the membrane to the cathode side. On the cathode side of the membrane, oxygen atoms react with the protons to produce water.

During a soak time period between a shutdown of normal operations and a restart of normal operations, some or all of the remaining unreacted hydrogen on the anode side migrates through the membrane and chemically reacts with the oxygen in the cathode side. Over time, depending upon the length of soak, hydrogen depletes in the anode side. Oxygen or air from the cathode side fills in the anode side to replace the lost hydrogen and increases an anode half cell potential.

Increasing the anode half cell potential destabilizes a ruthenium component of the anode catalyst layer, which may result in ruthenium migrating to the cathode catalyst. Loss of ruthenium on the anode catalyst layer may result in less efficient permeation of protons and may reduce the life of the fuel cell stack.

It is desirable to prevent oxygen and air from migrating to the anode side.

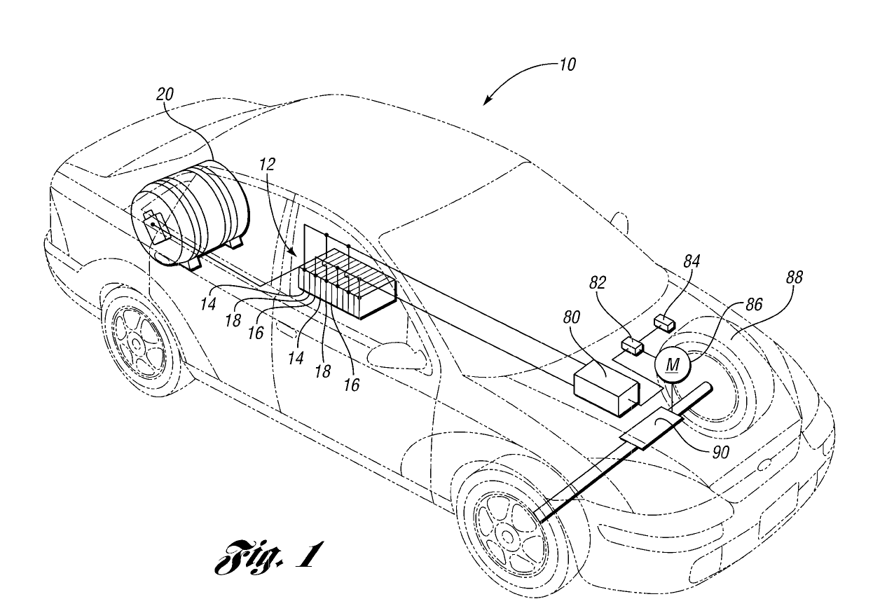

Regarding FIG. 1, a vehicle 10 is illustrated with a fuel cell 12 for powering the vehicle 10. While the vehicle 10 shown is a car, it should be understood that the vehicle 10 may also be other forms of transportation such as a truck, off-road vehicle, or an urban vehicle. The fuel cell 12 comprises an anode 14, a cathode 16, and a membrane 18 therebetween. A fuel cell stack comprises a plurality of such cells 12 wired serially and/or in parallel.

Fuel cell 12 electrically communicates with and provides energy to a high voltage bus 80. High voltage bus 80 electrically communicates with and provides energy to a d.c.-to-d.c. converter 82. The d.c.-to-d.c. converter 82 electrically communicates with both a battery 84 and a traction motor 86. The traction motor 86 is connected to a wheel 88 connected to the vehicle's 10 frame 90.

Further, while the fuel cell 12 is illustrated as supplying power for the traction motor 86, the fuel cell 12 may be used to power other aspects of the vehicle 10 without departing from the spirit or scope of the invention.

Connected directly or indirectly to the fuel cell 12 is a primary fuel source 20, such as a primary hydrogen source like an onboard hydrocarbon reformer. Non-limiting examples of the primary hydrogen source is a high-pressure hydrogen storage tank, an onboard hydrocarbon reformer, or a hydride storage device.

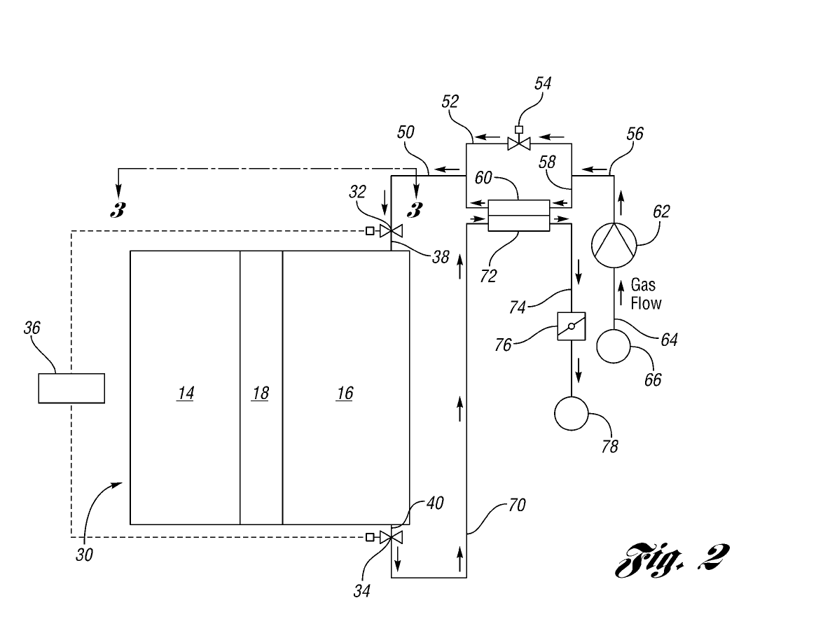

Regarding FIG. 2, a fuel cell 30 includes anode 14 and cathode 16 separated by membrane 18. Connected to cathode 16 is an input valve 32 for controlling the flow of air and/or oxygen. Also connected to cathode 16 is an output valve 34 which controls the flow of gas exiting the cathode 16. Valves 32 and 34 communicate with controller 36 which in at least one embodiment, controls the flow of gasses through the valves during opened and closed operational conditions.

Valves 32 and 34 may include, but are not limited to, gate valves, check valves, needle valves, ball valves, powered valves, reducing valves and plug valves.

In at least one embodiment, input valve 32 is disposed upstream of the cathode. Valve 32 may be disposed as close to cathode 32 as possible to minimize the retained oxygen in the conduit 38, such as a pipe, situated between valve 32 and cathode 16.

Similarly, in at least one embodiment, valve 34 is situated as closely as possible to cathode 16 such that conduit 40 has a minimal volume of retained gas.

Supplying air to valve 32 is an air supply conduit 50 which divides into a bypass conduit 52 which has a valve 54 disposed between conduit 50 and main oxygen supply 56. Main oxygen supply 56 also supplies conduit 58 into one side of a humidifier 60. Oxygen exits humidifier 60 and rejoins conduit 50. Conduit 56 is supplied pressurized air and/or oxygen by air compressor 62. Compressor 62 is supplied with air and/or oxygen through conduit 64 from a fuel source 66. Fuel source 66 may supply air, oxygen, and/or other fuels for the fuel cell.

Gas exiting from cathode 16 passes through conduit 40 and valve 34 and proceeds through conduit 70 to a second portion of 72 of humidifier 60. Gas coming from compressor 62 does not mix with gas coming from conduit 70 in humidifier 60. Gas exiting humidifier portion 72 passes through conduit 74 to a back pressure throttle valve 76. Gas passing through back pressure throttle valve 76 is directed to the vehicle exhaust system 78 where it leaves the fuel cell system.

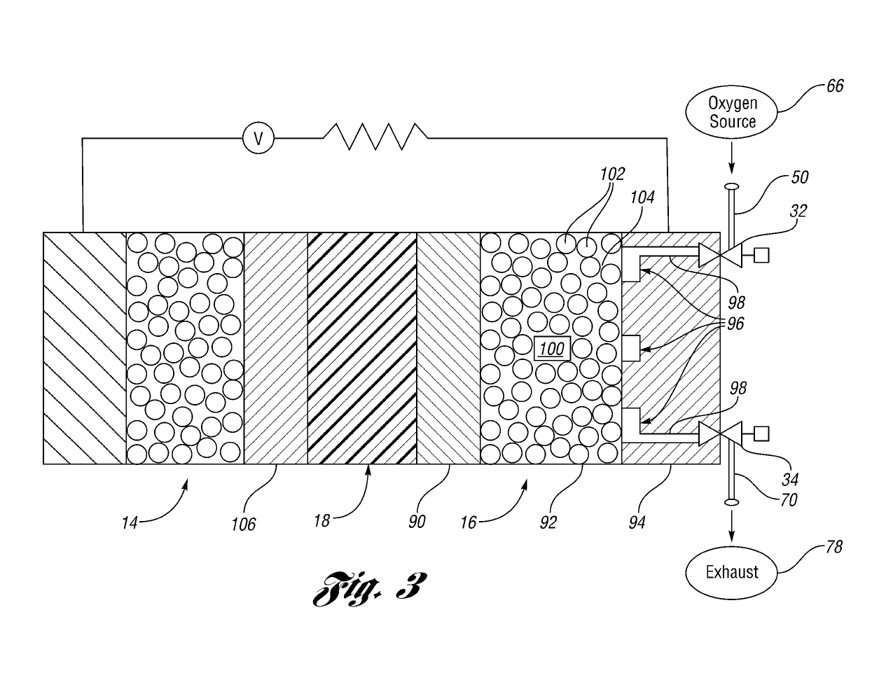

Turning now to FIG. 3, a cross-sectional view of the fuel cell is schematically illustrated according to at least one embodiment. Cathode 16 comprises a cathode catalyst 90 adjacent to membrane 18. Spaced apart from membrane 18 and adjacent to cathode catalyst 90 is gas diffusion layer 92. Adjacent to gas diffusion layer 92 is a plate 94. Plate 94 defines gas conduit 96 which is embedded into plate 94 and communicating with gas diffusion layer 92. Gas conduit 96 includes a pass-through gas conduit 98, which passes through the thickness of the plate 94. In at least one embodiment, the input valve 32 connects directly to the pass-through conduit 98 making pass-through conduit 98 identical to conduit 38. Input valve 32 receives oxygen or other fuel through conduit 50. Output valve 34 is connected to the other end of conduit 98 making conduit 98 identical to conduit 40. Conduit 70 exits valve 34 and directs the gas to exhaust 78.

Cathode catalyst 90 and plate 94 define cavity 100 into which gas diffusion layer 92 is situated. Between gas diffusion layer particles 102 are interstices 104. The volume of interstices 104 and gas conduit 96 and pass-through conduit 98 form a retained oxygen volume of cathode 16. In one or more embodiments, the retained oxygen volume is minimized during the soak time period.

Cathode catalyst 90 may facilitate reaction of hydrogen with the retained oxygen according to equation 1.

4H⁺+4e⁻+O₂→2H₂O [1]

Any unused oxygen of the retained oxygen may migrate across the catalyst layer 90 and membrane 18 to react with a anode catalyst layer 106. Reaction with anode catalyst layer 106 arises because of corrosion of a carbon component of anode catalyst layer 106.

The carbon corrosion reaction definition is given in equation 2.

C+2H₂O→CO₂+4H⁺+4e⁻ [2]

A degradation rate of the carbon component of anode catalyst layer 106 increases with increasing a half-cell potential of the carbon catalyst layer 106. Carbon corrosion in certain embodiments begins at a half-cell potential greater than 0.29 volts. In another embodiment, carbon corrosion begins at a half cell potential greater than 0.5 volts. In yet another embodiment, carbon corrosion begins at a half-cell potential greater than 1.2 volts. Carbon corrosion may result in loss of fuel cell performance and may shorten the stack life of the fuel cell 30.

Anode catalyst layer 106 also has a ruthenium compound component. When the anode half cell potential exceeds 0.55 volts, the ruthenium compound component of the anode catalyst layer 106 becomes unstable and starts migrating towards cathode 16. The ruthenium deposits on cathode catalyst layer 90. The reaction is defined as given below in equation 3.

Ru→Ru³⁺+3e⁻ [3]

In one or more embodiments, the objective is to minimize the ruthenium in this cathode catalyst layer 90. The deposition of ruthenium on cathode catalyst layer 90 may result in reduced rates of oxidation reduction reactions at the cathode catalyst layer 90. Loss of ruthenium on the anode catalyst layer 106 may result in less efficient permeation of protons through the anode catalyst layer 106. The net result of the ruthenium migration may be a shorter stack life of the fuel cell 30.

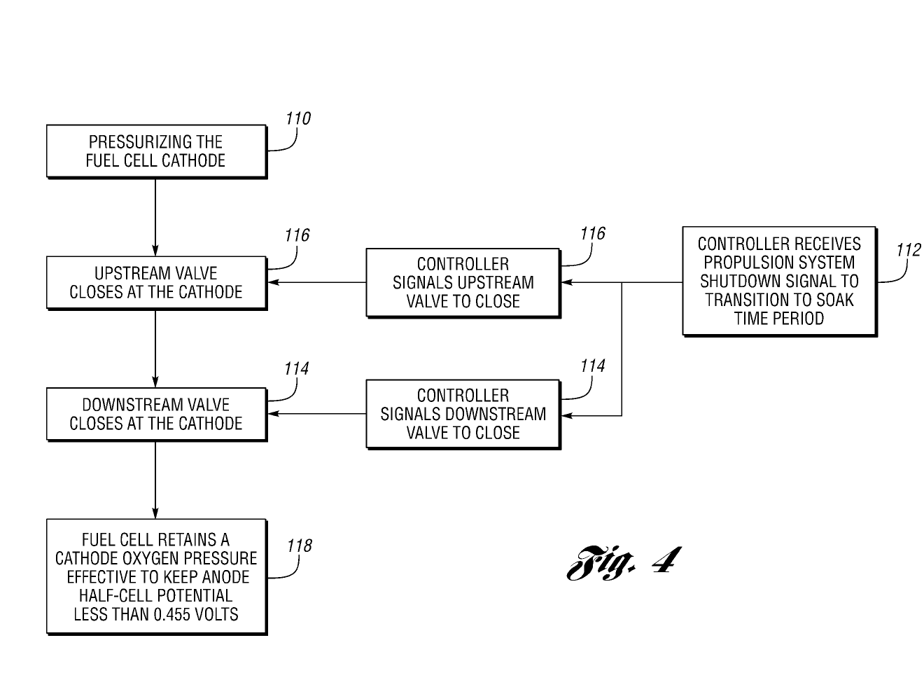

In at least one embodiment, the fuel cell system can be operated when a vehicle propulsion system transitions to a non-operational condition, such as a soak time period from an operational condition, such as a propulsion system operating time period. The fuel cell system, in another embodiment, may be used when a vehicle propulsion system transitions to the operational condition from the non-operational condition. The method includes steps of pressurizing the fuel cell cathode with oxygen in step 110 of FIG. 4. The oxygen is supplied through the oxygen inlet valve 32. In step 112, controller 36 receives a first signal to transition to a soak time period operational condition. In step 114, the controller transmits a second signal to valve 34 closing valve 34. In at least one embodiment, the signal is directly or indirectly transmitted from a propulsion system electrical system. The controller also transmits another signal in step 116 to valve 32 closing valve 32.

In at least one embodiment, during the soak period, the anode half cell potential is maintained at less than 0.455 volts in step 118. In another embodiment, the anode half cell potential is less than 0.85 volts. In yet another embodiment, the anode half cell potential is kept to less than 1.2 volts.

The cathode oxygen pressure in at least one embodiment decreases or remains the same during the soak time period.

Although the best mode for carrying out the invention has been described in detail, those familiar with the art to which this invention relates will recognize various alternative designs and embodiments for practicing the invention as defined by the following claims.

What is claimed:

1. A fuel cell system, comprising:
a fuel cell having a cathode and an anode, the cathode having an inlet and an outlet;
at least one of a first valve and a second valve, the first valve being situated at and connected to the cathode inlet, the second valve being situated at and connected to the cathode outlet; and
a controller configured to control the first and second valves during a first operating condition and a second operating condition, the first operating condition being the transition of the fuel cell system from an operational state to a non-operational state, the second operating condition being the transition from a non-operational state to an operational state.

2. The system of claim 1, wherein the non-operational state includes a soak time period.

3. The system of claim 1, wherein the controller is configured to close at least one valve during the transition from the first operating condition and the second operating condition.

4. The system of claim 1, wherein the controller is configured to close both the first and second valves during the transition from the first operating condition to the second operating condition.

5. The system of claim 1, wherein both the first valve and the second valve are situated at and are connected to the cathode.

6. The system of claim 1, wherein at least one of the first and second valves is connected to the cathode by a conduit having no intermediate connections between the valve and the cathode.

7. The system of claim 1, wherein at least one of the first and second valves is embedded in the cathode.

8. The system of claim 1, wherein the non-operational condition has a maximum anode half-cell potential less than 0.455 volts.

9. The system of claim 1, further comprising:
a back pressure valve disposed downstream of the first valve, the backpressure valve being capable of regulating air pressure in the cathode.

10. The system of claim 1, further comprising:
a compressor; and
a humidifier, wherein the compressor communicates with the humidifier which communicates with the first valve.

11. A fuel cell system, comprising:
a fuel cell having an anode having a half-cell potential, a cathode including a cathode catalyst layer, a plate spaced apart from the cathode catalyst layer and defining a cavity therebetween, the cavity including a gas diffusion layer communicating with a gas conduit defined by the plate, the cathode further including an oxygen input situated at an upstream end of the gas conduit and an gas outlet situated at a downstream end of the gas conduit;
a first valve situated adjacent to the oxygen inlet;
a second valve situated adjacent to the gas outlet; and
a conduit connecting the first and second valves to the cathode, the conduit having no intermediate connection therebetween.

12. The system of claim 11, wherein the amount of retained oxygen is insufficient to generate a maximum anode half-cell potential exceeding 0.455 volts.

13. The system of claim 11, wherein the controller includes at least two operational states.

14. The system of claim 13, wherein at least one of the two, the first and second valves are closed during at least one of the at least two operating states.

15. The system of claim 11, wherein the plate is a cathode graphite plate having a surface adjacent to the gas diffusion layer and a spaced apart surface adjacent to the exterior of the fuel cell.

16. The system of claim 11, wherein at least one of the valves is situated immediately adjacent to the plate.

17. The system of claim 11, wherein the cathode plate is substantially parallel to the cathode catalyst layer.

18. A method of operating a fuel cell system during a vehicle transition to a soak time period, the fuel cell system including a cathode and an anode, the anode having an anode half-cell potential, the method comprising the steps of:
(a) pressurizing the fuel cell cathode with oxygen at a cathode oxygen pressure, the cathode having an oxygen inlet and a gas outlet;
(b) transmitting a first signal to a controller to begin the soak time period;
(c) transmitting a second signal from the controller to a first valve situated at the oxygen inlet;
(d) closing the first valve in response to the second signal;
(e) transmitting a third signal from the controller to a second valve situated at the gas outlet; and
(f) closing a second valve in response to the third signal, during the vehicle transition.

19. The method of claim 18, further comprising the step of:
(g) maintaining the anode half cell potential less than 0.455 volts.

20. The method of claim 18, wherein the cathode oxygen pressure decreases or remains the same during the soak time period.
